(19) United States
(12) Patent Application Publication
(10) Pub. No.: US 2026/0003593 A1
(43) Pub. Date: Jan. 1, 2026

(54) PRIORITIZED CHAOS TESTING WITH EDGE DEVICES

(71) Applicant: Dell Products L.P., Round Rock, TX (US)

(72) Inventors: BORIS SHPILYUCK, Ashdod (IL); MAXIM BALIN, Gan-Yavne (IL); IGOR DUBROVSKY, Beer Sheva (IL)

(21) Appl. No.: 18/756,230

(22) Filed: Jun. 27, 2024

(51) Int. Cl. G06F 8/61

(52) U.S. Cl. CPC G06F 8/61

(57) ABSTRACT

Methods and systems for managing operation of a deployment are disclosed. The deployment may be managed by prioritizing chaos testing of services. The chaos testing may be prioritized by assigning an accessibility weight to a service of the services and selecting the service to perform chaos testing based on the accessibility weight. The accessibility weight may be measure of significance of a service to an ability of the deployment to continue to operate. Services with higher accessibility weights may be selected with which to perform chaos testing. By selecting the services with higher accessibility weights, time and resources of a deployment may not be significantly impacted and may be further allocated to a provision of computer implemented services.

### FIELD

Embodiments disclosed herein relate generally to managing operation of a deployment. More particularly, embodiments disclosed herein relate to prioritizing chaos testing of services with edge devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a deployment. The deployment may be managed by prioritizing chaos testing of services with edge devices in the deployment. The chaos testing may be prioritized by assigning an accessibility weight to a service of the service.

The accessibility weight may be a measure of significance of a service to an ability of the deployment to continue to operate. Therefore, a higher the accessibility weight may indicate that a failure of the service may affect an operation of the deployment more significantly.

To improve a reliability of the deployment, chaos testing may be performed. Rather than performing the chaos testing on all services in a deployment, the services with higher accessibility weights may be prioritized for the chaos testing. The prioritization may reduce time and resources used for chaos testing, so that a provision of computer implemented services by the deployment may not be impacted.

In an embodiment, a method for managing operation of a deployment is disclosed. The method may include (i) identifying an occurrence of a testing event for the deployment; (ii) identifying services hosted by the deployment, based on the occurrence; (iii) obtaining accessibility weights for the services; (iv) selecting, using the accessibility weights and selection criteria, a portion of the services; (v) performing testing on only a selected portion of the services during a deployment testing window to obtain a set of testing results; (vi) updating operation of the deployment using the set of testing results to obtain an updated deployment; and (vii) providing computer implemented services using the updated deployment.

An accessibility weight of the accessibility weights may be a measure of significance of a service of the services to an ability of the deployment to continue to operate.

A value of the accessibility weight may be determined by a system operator for the deployment or by a developer of software for the service.

Obtaining the accessibility weights for the services may include (i) obtaining a service identifier for a service of the services; (ii) obtaining application programming interface identification information for an application programming interface associated with the service; and (iii) obtaining, using the application programming interface identification information, an accessibility weight of the accessibility weights from the application programming interface.

The selection criteria may be a standard usable to discriminate a portion of the accessibility weights from other accessibility weights of the accessibility weights.

Selecting, using the accessibility weights and selection criteria, the portion of the services may include (i) qualifying, based on the standard, the portion of the accessibility weights; (ii) identifying a second portion of the services that is associated with the portion of the accessibility weights; and (iii) selecting the second portion of the services to be part of the portion of the services.

Performing testing on only the selected portion of the services during the deployment testing window to obtain the set of testing results may include (i) inducing a failure in a service of the selected portion of the services to obtain at least partially dysfunctional services; and (ii) performing at least one diagnostic test on the at least partially dysfunctional services to obtain the testing results.

The service of the selection portion of the services may be selected for inducement of the failure based on the service having a higher associated accessibility weight than other services of the selected portion of the services, and the other services of the selected portion of the services being selected for failure inducement in an order defined by the associated accessibility weights.

The method may further include, before obtaining the accessibility weights: (i) obtaining sub-accessibility weights for microservices of a service of the services; and (ii) summing the sub-accessibility weights to obtain an accessibility weight of the accessibility weights for the microservice.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

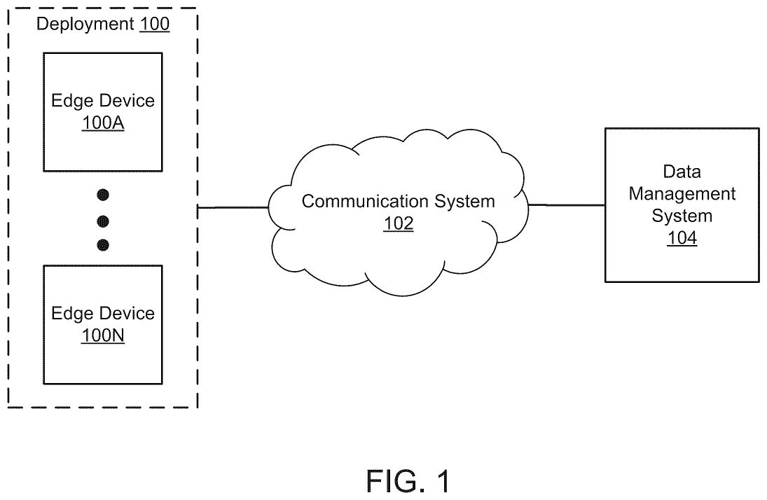

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a service architecture may be used to provide services in a deployment. A service architecture may structure and manage services that cooperate with each other in a software application. A service of the services may perform tasks independently of other services in the software application. Some of the services may fail only under very specific circumstances. Consequently, during normal operation of a system, such potential failures are unlikely to be identified.

To identify such failures, chaos testing may be performed to induce the specific conditions to occur (e.g. through brute force exhaustive testing). However, performing chaos testing may expend a significant amount of time and resources by the deployment and, therefore, can crowd out the desired services. By expending the significant amount of time and resources, provisioning of computer implemented services by the deployment may be impacted (e.g., by restricting the type/quantity/quality of the services for lack of available computing resources).

In general, embodiments disclosed here relate to systems and methods for managing operation of a deployment. The operation may be managed by assigning an accessibility weight to a service. The accessibility weight may give a measure of significance of the service to an ability of the deployment to continue operation. A higher accessibility weight assigned to the service may include a more significant disruption to operation of the deployment if the service experiences a failure.

After assignment of accessibility weights, services may be selected for chaos testing. The chaos testing may be performed to improve the services. However, performing the chaos testing with all of the services may expend a significant amount of time and resources by the deployment.

To reduce the amount of time and resources expended by the deployment while improving the services, the accessibility weights may be used to select services for the chaos testing. The accessibility weights may be used by applying a selection criterion to select a portion of the services. For example, the selection criteria may mandate selection of the portion of the services having five highest accessibility weights. As a result, the portion of the services may include five services of the services with the highest accessibility weights. Further, the selection criteria may mandate the chaos testing of the five services from highest to lowest accessibility weight.

The chaos testing may be performed starting with one service of the five services having the highest accessibility weight. To perform the chaos testing, a failure may be induced in the service to obtain dysfunctional services. A diagnostic test may then be performed on the dysfunctional services to obtain testing results. The testing results may be analyzed to understand an impact of the failure on the deployment. After understanding the impact of the failure, updates may be applied to the services to produce an updated deployment. The updated deployment may improve a likelihood of provision of computer implemented services.

To provide the above noted functionality, the system may include deployment 100 and deployment manager 104. Each of these components is discussed below.

Deployment 100 may include any number of data processing systems 100A-100N.

Data processing systems 100A-100N may include a service architecture that provides services. A service architecture may include a collection of loosely-coupled, independently deployable microservices. For example, a service architecture for an e-commerce application may be divided by the following services: user service (managing user accounts and authentication), product service (handling product listings and inventory), order service (managing order creation and processing), etc. Operation of the services may provide computer implemented services. To test resilience and to understand how deployment 100 may respond to failures in the operation, deployment manager 104 may perform chaos testing on a portion of the services. The portion of the services may be determined by deployment manager 104.

Deployment manager 104 may manage an integrity of the services in deployment 100. To manage the integrity, deployment manager 104 may perform chaos testing on the portion of the services in deployment 100. Deployment manager 104 may perform the chaos testing by inducing failure in the portion of the services that have higher accessibility weights than accessibility weights of a remaining portion of the services.

An accessibility weight of the accessibility weights may give a measure of significance of the service to an ability of the deployment to continue operation. Deployment manager 104 may receive the accessibility weight of a service from a system operator of deployment 100 or a developer of software for the service.

After the failure is induced in the portion of the services in deployment 100, dysfunctional services may be obtained from deployment 100. Deployment manager 104 may perform a diagnostic test on the dysfunctional services to obtain testing results. Deployment manager may analyze the testing results to understand an impact of the failure on deployment 100.

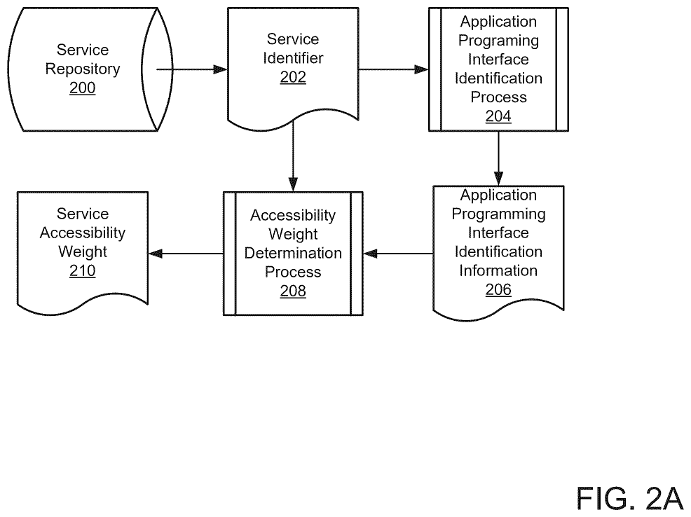

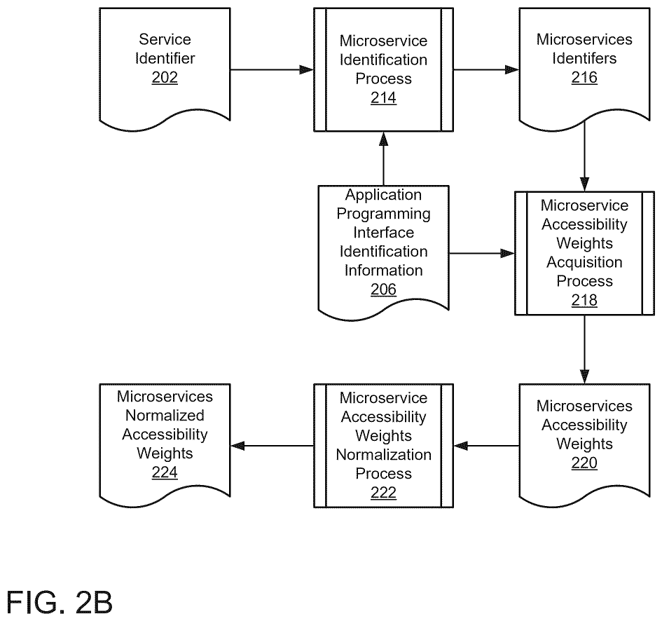

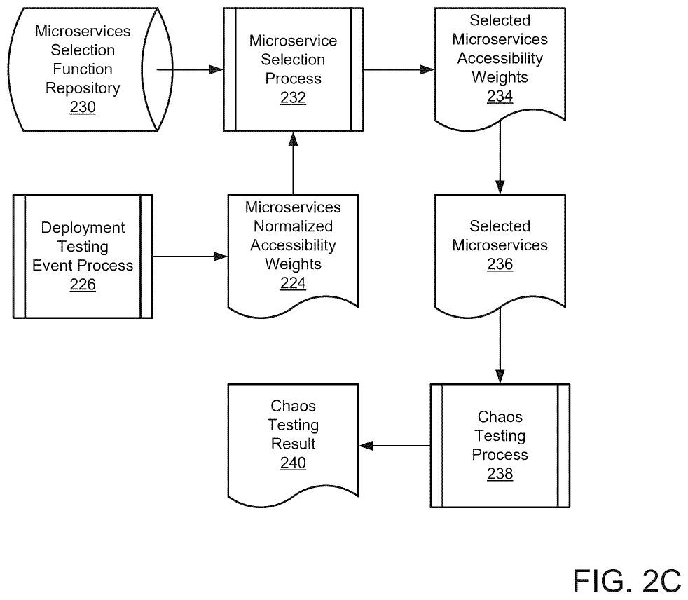

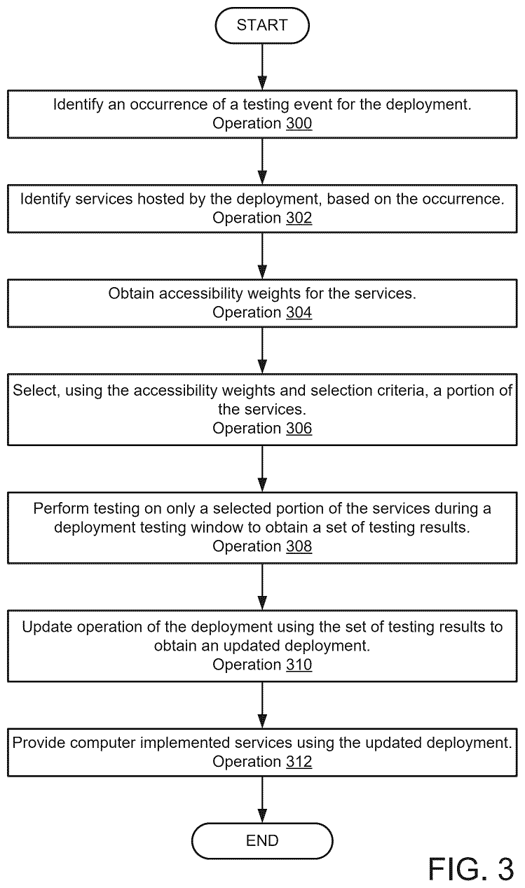

While providing their functionality, any of deployment 100 and deployment manager 104 may perform all, or a portion, of the flows and methods shown in FIGS. 2A-3.

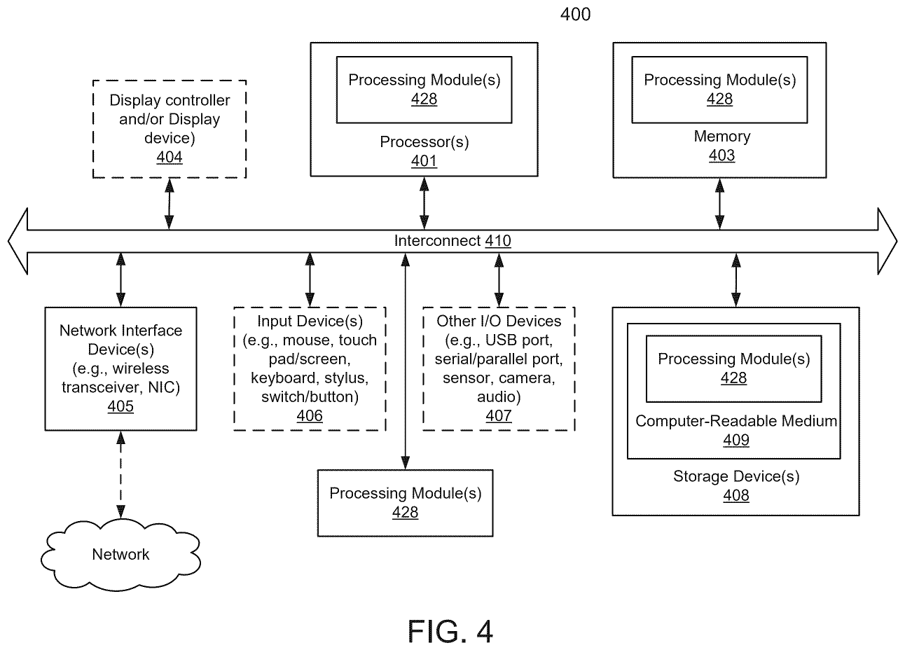

Any of (and/or components thereof) deployment 100 and deployment manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 202, 206, etc.) is used to represent data structures, a second set of shapes (e.g., 204, 208, etc.) is used to represent processes performed using and/or that generate data, and a third set of shapes (e.g., 200, 230 etc.) is used to represent large scale data structures such as databases.

Turning to FIG. 2A, a first data flow diagram in accordance with an embodiment is shown. The first data flow diagram may illustrate data used in and data processing performed in determining the accessibility weight for a service.

To determine the accessibility weight for the service, application programming interface identification process 204 may be performed. During application programming interface identification process 204, service repository 200 may be accessed. Service repository 200 may be accessed by checking service repository 200 for the service.

Service repository 200 may include registry of services that can be performed in a deployment (e.g., 100). The registry of the services may include service identifiers, service descriptions, paths to an application programming interface (API) that is used by the service, a status of the service (e.g., running, paused, etc.), etc.

If the service is found in service repository 200, service identifier 202 may be extracted. Service identifier 202 may include a display name used to identify the service in service repository 200. Service identifier 202 may be ingested by application programming interface identification process 204.

Upon ingestion of service identifier 202 by application programming interface identification process 204, application programming interface identification information 206 may be extracted. Application programming interface identification information 206 may be extracted by performing a lookup of the API used by the service. The lookup may return any number of records. A record of the records may include data such as a name for the record, a version of the API, a data structure with, for example, keys and values for each key of the keys, etc. The record may include application programming interface identification information 206.

Once application programming interface identification information 206 is retrieved, accessibility weight determination process 208 may be performed. During accessibility weight determination process 208, a lookup may be performed for service accessibility weight 210. The lookup may be performed by performing an API call with service identifier 202. Service accessibility weight 210 may be included in a record that is returned from the lookup. Service accessibility weight 210 may be an accessibility weight for the service. Service accessibility weight 210 may give a measure of significance of the service to an ability of the deployment to continue operation.

The lookup may be performed by performing an API call for a record that includes service accessibility weight 210. The lookup may be necessary because a developer of the API may have stored service accessibility weight 210 as data within the API. Further, to use the API in a deployment (e.g., 100), a system operator of the deployment (e.g., 100) may have reviewed and validated service accessibility weight 210 upon storage as data within the API. The API call may return the record which may include service accessibility weight 210.

Thus, via the data flow illustrated in FIG. 2A, a system in accordance with an embodiment may determine accessibility weights for a service. Consequently, a deployment (e.g., 100) may be more likely to be able to provide desired computer implemented services by ascribing a measure of significance of the service to an ability of the deployment to continue to operate.

Turning to FIG. 2B, a second data flow diagram in accordance with an embodiment is shown. The second data flow diagram may illustrate data used in and data processing performed in determining accessibility weights for microservices.

To determine the accessibility weights for the microservices, microservices identification processes 214 may be performed. During microservices identification processes 214, service identifier 202 may be ingested. Ingestion of service identifier 202 and application programming interface identification information 206 may be performed to identify the service. The service may be identified by performing a lookup of the application programming interface (API) with service identifier 202. The lookup may be performed by performing an API call with service identifier 202.

The lookup may return any number of records. A record of the record may include the service, service accessibility weight 210, etc. The lookup may also include a list of the microservices of the service. Microservices identifiers 216 may use naming conventions that clarify which microservice handles which functionality. For example, (i) “user-service” may handle authentication, registration, preferences, etc. of users; (ii) “analytics-service” may handle collection and analysis of data to provide insights into behaviors, system performance, business metrics, etc., and (iii) “inventory-service” may manage inventory levels, track stock availability and/or update product availability status, etc.

Using microservice identifiers 216 and application programming interface identification information 206, microservice accessibility weights acquisitions process 218 may be performed. During microservice accessibility weights acquisitions process 218, a lookup may be performed with the API. The lookup may be performed by performing an API call for each microservice identifier of microservices identifiers 216.

The lookup may return any number of records. Each record of the records may include a microservice accessibility weights for each of the microservices from the API. Microservices accessibility weights 220 may include all of the microservice accessibility weights of the microservices. The sum of microservices accessibility weights 220 may equal service accessibility weights 210.

Once microservices accessibility weights 220 have been obtained, microservices accessibility weights normalization process 222 may be performed. During microservices accessibility weights normalization process 222, microservices accessibility weights 220 may be normalized. Microservices accessibility weights 220 may be normalized by, for each microservice accessibility weight of microservices accessibility weights 220, (i) subtracting a smallest microservice accessibility weight of microservices accessibility weights 220 from a microservice accessibility weight to obtain a first difference, (ii) subtracting the smallest microservice accessibility weight of microservices accessibility weights 220 from a largest microservice accessibility weight of microservices accessibility weights 220 to obtain a second difference; and (iii) dividing the first difference by the second difference. As a result, microservices normalized accessibility weights 224 may be computed.

Thus, via the data flow illustrated in FIG. 2B, a system in accordance with an embodiment may determine accessibility weights for microservices of a service.

Consequently, a deployment (e.g., 100) may be more likely to be able to provide desired computer implemented services by ascribing a measure of significance of a microservice of the microservices to an ability of the deployment to continue to operate.

Turning to FIG. 2C, a third data flow diagram in accordance with an embodiment is shown. The third data flow diagram may illustrate data used in and data processing performed in performing chaos testing on selected microservices.

To perform the chaos testing, deployment testing event process 226 may be performed. During deployment testing event process 226, a need to may be present to understand a response by a deployment (e.g., 100) to various disruptive events. The disruptive events may include, for example, simulating server outages, server dependency issues, power and network failures, configuration changes, etc. Depending on a type of disruptive event, a lookup may be performed, as described in descriptions of FIGS. 2A-2B, to microservices normalized accessibility weights 224. Microservices normalized accessibility weights 224 may be normalized accessibility weights assigned to microservices that are related to a disruptive event for the deployment.

In addition, a microservice may be selected from microservices selection function repository 230. Microservices selection function repository 230 may include a registry of types of selection criteria. The types of selection criteria may be used to select any number of accessibility weights from a set of accessibility weights. Examples of selection criteria include a set of five highest accessibility weights of microservices normalized accessibility weights 224, the set of top twenty percent of accessibility weights of microservices normalized accessibility weights 224, etc.

From microservices of microservices selection function repository 230, microservice selection process 232 may be performed. During microservice selection process 232, the selection criteria may be applied to microservices normalized accessibility weights 224. The selection criteria may be applied by selecting a subset of microservices normalized accessibility weights 224 based on the selection criteria. For example, consider that microservices normalized accessibility weights 224 includes sixty accessibility weights, each accessibility weight for a microservice. Also consider that the selection criteria may choose the top twenty percent of the accessibility weights. Therefore, the top twenty percent of the sixty accessibility weights may be twelve accessibility weights having higher values than the remaining forty-eight accessibility weights. The twelve accessibility weights may accessibility weights for selected microservices 236.

Using selected microservices 236, chaos testing process 238 may be performed. During chaos testing process 238, a failure may be induced in a service of selected microservices 236 to obtain dysfunctional services. A failure may be introduced, for example, in data read by a database service of selected microservices 236. A result of chaos testing process 238 may be chaos testing result 240. Chaos testing result 240 may include, for example, database failures, disk corruption, and/or accidental disk deletion that may lead to data integrity issues, leading to data loss or inconsistent data states. The database service, having an accessibility weight in selected microservices 236, may significantly affect a deployment (e.g., 100) because selected microservices 236 includes higher values of accessibility weights among microservices accessibility weights 228.

Chaos testing result 240 may be analyzed to understand an impact of the failure on the deployment (e.g., 100). After understanding the impact of the failure, updates may be applied to the service to produce an updated deployment. The updated deployment may improve a likelihood of provision of computer implemented services.

Thus, via the data flow illustrated in FIG. 2C, a system in accordance with an embodiment may perform chaos testing on selected microservices. Consequently, a deployment (e.g., 100) may be more likely to be able to provide desired computer implemented services by updating the deployment based on an analysis of a testing result from the chaos testing. An update of the deployment may be based on a testing result from chaos testing of selected microservices that significantly affect the deployment.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a deployment. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a deployment in accordance with an embodiment is shown. The method may be performed, for example, by any of the components of the system of FIG. 1, and/or other components not shown therein.

At operation 300, an occurrence of a testing event may be identified for a deployment. The occurrence of the testing event may be identified by anticipating unexpected failures from, for example, power outages, increased scaling of the deployment, mandated compliance requirements, reproduction of past incidents that cause dysfunctional services, etc.

At operation 302, services hosted by the deployment may be identified, based on the occurrence. The services may be identified by performing a call to an application programming interface (API) for the services associated with the testing event.

At operation 304, accessibility weights may be obtained for the services. The accessibility weights may be obtained by (i) obtaining a service identifier for a service of the services; (ii) obtaining application programming interface identification information for an application programming interface associated with the service; and (iii) obtaining, using the application programming interface identification information, an accessibility weight of the accessibility weights from the application programming interface.

The service identifier may be obtained by performing a lookup in a registry of services in the deployment for a service of the services. When the service is found, the service identifier may part of a description of the service. Application programming interface identification information may be obtained by performing a first API call used by the service. The first API call may return a first record. The first record may include application programming interface identification information. The accessibility weight may be obtained by performing a second API call with the service identifier. The second API call may return a second record. The second record may include the service identifier.

At operation 306, a portion of the services may be selected using the accessibility weights and selection criteria. The portion of the services may be selected by (i) qualifying, based on the standard, the portion of the accessibility weights; (ii) identifying a second portion of the services that is associated with the portion of the accessibility weights; and (iii) selecting the second portion of the services to be part of the portion of the services.

The portion of the accessibility weights may be qualified by comparing a value of a accessibility weight of the accessibility weights to a standard of the selection criteria. If the value of the accessibility weight meets the standard, then the accessibility weight may be qualified. For example, if the standard calls for a highest five accessibility weights of the accessibility weights and the accessibility weight is a fourth highest accessibility weight of the accessibility weights, then the accessibility weight may meet the standard. Because the accessibility weight meets the standard, then the accessibility weight may be qualified.

The second portion of the services may be identified by matching a qualified accessibility weight of the accessibility weights to a service. A set of qualified accessibility weights may be associated with the second portion of the services. The second portion of the services may be selected by setting apart the second portion of the services from the services. The second portion of the services may be set apart from the services by listing service identifiers of the second portion of the services, each of the service identifiers to be used to identify the service during the testing event.

At operation 308, testing may be performed on only a selected portion of the services during a deployment testing window to obtain a set of testing results. The selected portion of the services may be the second portion of the services. The testing may be performed by (i) inducing a failure in a service of the selected portion of the services to obtain at least partially dysfunctional services and (ii) performing at least one diagnostic test on the at least partially dysfunctional services to obtain the testing results.

The failure may be induced in the service by introducing disruptions, faults, and/or stressors into the deployment (e.g., 100). Examples may include (i) manipulating resources (e.g., central processing unit (CPU), memory, etc.); (ii) causing service interruptions (e.g., stopping and/or restarting components, etc.); (iii) injecting errors in layers of an application programming interface (API) used by the service; (iv) simulating network issues (e.g., latency, packet loss, etc.), etc. The disruptions, the faults, and/or the stressors may produce dysfunctional services. The at least one diagnostic test may be performed by (i) analyzing the impact of an induced failure and (ii) gathering insights into a behavior of the deployment (e.g., 100) as a result of the disruptions, the faults, and/or the stressors.

At operation 310, an operation of the deployment (e.g., 100) may be updated using the set of testing results to obtain an updated deployment. The operation may be updated by performing any necessary improvements to the deployment (e.g., 100). The necessary improvements may include software updates, configuration changes, service architecture enhancements, etc.

At operation 312, computer implemented services may be provided using the updated deployment (e.g., 100). The computer implemented services may be provided by running services using the updated deployment (e.g., 100).

The method may end following operation 312.

Thus, via the method shown in FIG. 3, embodiments herein may likely improve a likelihood of managing operation of a deployment. By improving the likelihood of managing operation of a deployment that provide computer implemented services, the deployment may be more likely to provide desirable computer implemented services by, for example, reducing a likelihood of failure in the deployment by running a service, improving a reliability of a service in the deployment, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
identifying an occurrence of a testing event for the deployment;
based on the occurrence:
identifying services hosted by the deployment;
obtaining accessibility weights for the services;
selecting, using the accessibility weights and selection criteria, a portion of the services;
testing only the portion of the services during a deployment testing window to obtain a set of testing results;
updating operation of the deployment using the set of testing results to obtain an updated deployment; and
providing computer implemented services using the updated deployment.

2. The method of claim 1, wherein an accessibility weight of the accessibility weights is a measure of significance of a service of the services to an ability of the deployment to continue to operate in a predetermined manner.

3. The method of claim 2, wherein a value of the accessibility weight is determined by a system operator for the deployment or by a developer of software for the service.

4. The method of claim 1, wherein obtaining the accessibility weights for the services comprises:
obtaining a service identifier for a service of the services;
obtaining application programming interface identification information for an application programming interface associated with the service; and
obtaining, using the application programming interface identification information, an accessibility weight of the accessibility weights from the application programming interface.

5. The method of claim 1, wherein the selection criteria is a standard usable to discriminate a portion of the accessibility weights from other accessibility weights of the accessibility weights.

6. The method of claim 5, wherein selecting, using the accessibility weights and selection criteria, the portion of the services comprises:
qualifying, based on the standard, the portion of the accessibility weights;
identifying a second portion of the services that is associated with the portion of the accessibility weights; and
selecting the second portion of the services to be part of the portion of the services.

7. The method of claim 1, wherein testing only the portion of the services during the deployment testing window to obtain the set of testing results comprises:
inducing a failure in a service of the portion of the services to obtain at least partially dysfunctional services; and
performing at least one diagnostic test on the at least partially dysfunctional services to obtain the testing results.

8. The method of claim 7, wherein the service of the portion of the services is selected for inducement of the failure based on the service having a higher associated accessibility weight than other services of the portion of the services, and the other services of the portion of the services being selected for failure inducement in an order defined by the associated accessibility weights.

9. The method of claim 1, further comprising:
before obtaining the accessibility weights:
obtaining sub-accessibility weights for microservices of a service of the services; and
summing the sub-accessibility weights to obtain an accessibility weight of the accessibility weights for the microservice.

10. A non-transitory machine-readable medium having instructions stored therein, which when executed by a processor, cause the processor to perform operations for managing operation of a deployment, the operation comprising:
identifying an occurrence of a testing event for the deployment;
based on the occurrence:
identifying services hosted by the deployment;
obtaining accessibility weights for the services;
selecting, using the accessibility weights and selection criteria, a portion of the services;
testing only the portion of the services during a deployment testing window to obtain a set of testing results;
updating operation of the deployment using the set of testing results to obtain an updated deployment; and
providing computer implemented services using the updated deployment.

11. The non-transitory machine-readable medium of claim 10, wherein an accessibility weight of the accessibility weights is a measure of significance of a service of the services to an ability of the deployment to continue to operate in a predetermined manner.

12. The non-transitory machine-readable medium of claim 11, wherein a value of the accessibility weight is determined by a system operator for the deployment or by a developer of software for the service.

13. The non-transitory machine-readable medium of claim 10, wherein obtaining the accessibility weights for the services comprises:
obtaining a service identifier for a service of the services;
obtaining application programming interface identification information for an application programming interface associated with the service; and
obtaining, using the application programming interface identification information, an accessibility weight of the accessibility weights from the application programming interface.

14. The non-transitory machine-readable medium of claim 10, wherein the selection criteria is a standard usable to discriminate a portion of the accessibility weights from other accessibility weights of the accessibility weights.

15. The non-transitory machine-readable medium of claim 14, wherein selecting, using the accessibility weights and selection criteria, the portion of the services comprises:
qualifying, based on the standard, the portion of the accessibility weights;
identifying a second portion of the services that is associated with the portion of the accessibility weights; and
selecting the second portion of the services to be part of the portion of the services.

16. A data processing system, comprising:
a processor; and
a memory coupled to the processor to store instructions, which when executed by the processor, cause the processor to perform operations managing operation of a deployment, the operations comprising:
identifying an occurrence of a testing event for the deployment;
based on the occurrence:
identifying services hosted by the deployment;
obtaining accessibility weights for the services;
selecting, using the accessibility weights and selection criteria, a portion of the services;
testing only the portion of the services during a deployment testing window to obtain a set of testing results;
updating operation of the deployment using the set of testing results to obtain an updated deployment; and
providing computer implemented services using the updated deployment.

17. The data processing system of claim 16, wherein an accessibility weight of the accessibility weights is a measure of significance of a service of the services to an ability of the deployment to continue to operate in a predetermined manner.

18. The data processing system of claim 17, wherein a value of the accessibility weight is determined by a system operator for the deployment or by a developer of software for the service.

19. The data processing system of claim 16, wherein obtaining the accessibility weights for the services comprises:
obtaining a service identifier for a service of the services;
obtaining application programming interface identification information for an application programming interface associated with the service; and
obtaining, using the application programming interface identification information, an accessibility weight of the accessibility weights from the application programming interface.

20. The data processing system of claim 16, wherein the selection criteria is a standard usable to discriminate a portion of the accessibility weights from other accessibility weights of the accessibility weights.
